(19) United States
(12) Patent Application Publication
(10) Pub. No.: US 2016/0173422 A1
(43) Pub. Date: Jun. 16, 2016

(54) MESSAGE DELIVERY VIA PREFERRED COMMUNICATIONS APPLICATIONS

(71) Applicant: HEWLETT-PACKARD DEVELOPMENT COMPANY, L.P., Houston, TX (US)

(72) Inventors: Adi Kidron, Yehud (IL); Eitan Katz, Yehud (IL)

(21) Appl. No.: 14/909,488

(22) PCT Filed: Aug. 28, 2013
(86) PCT No.: PCT/US2013/056944

§ 371 Date: Feb. 2, 2016

(51) Int. Cl. H04L 12/58; G06Q 10/10; H04L 29/08

(52) U.S. Cl. CPC H04L 51/046; H04L 67/18; G06Q 10/1095

(57) ABSTRACT

In one example of the disclosure, data indicative of a current message, sent via a first communications application for delivery to a user, is accessed. A preferred communications application is identified for delivering the current message to the user. Identification is in consideration of past behaviors of the user with respect to communication applications. The current message is caused to be delivered to the user via the preferred application.

### BACKGROUND

Handheld computing devices, notebook computers, desktop computers, smartphones and other computing devices frequently have installed a variety of applications that provide communications functionality. Such communications applications will enable a user to, among other things, send, receive and store messages.

### DRAWINGS

FIG. 1 is a block diagram depicting an example environment in which various embodiments may be implemented.

FIG. 2 is a block diagram depicting an example of a system for message delivery via preferred communications applications.

FIG. 3 is a block diagram depicting an example data structure for message delivery via preferred communications applications.

FIG. 4 is a block diagram depicting a memory resource and a processing resource according to an example.

FIG. 5 is a block diagram depicting an example of message delivery via preferred communications applications.

FIG. 6 is a flow diagram depicting steps taken to implement an example.

FIG. 7 is another flow diagram depicting steps taken to implement an example.

### DETAILED DESCRIPTION

INTRODUCTION: Having an abundance of communications applications installed on a smartphone or other computing device can be an attractive proposition in many use cases. A user of the smartphone will have the flexibility to respond to quickly respond to messages sent by contacts in a format and manner that is presumably comfortable to the contacts. This arrangement can also be attractive if the smartphone user, and his or her contacts, have a discipline to utilize a certain applications for certain events (e.g., work events), and another communications application for other events (e.g., family events).

Given the positive aspects of having multiple communications applications on smartphone, there are also can be significant drawbacks. Even the most organized of smart phone users will find it challenging to organize their use of communications applications in light of the multitude of family, friends and workplace contexts that the user operates in. For example, the simple idea of using an application for work and a separate application for home quickly become untenable given that there may be a variety of work contexts (e.g., priority projects, normal projects, team-building, etc.) and a variety of home contexts (e.g., immediate family, parents, close friends, college friends, acquaintances, etc.). The matter is further complicated by the issue of timing. For instance, a message from a work colleague that has a certain context during working hours may take on an entirely new context if the smart phone user is driving or is another context such that the user will not be frequently checking work messages. The smart phone user will thus invariably receive via communications applications messages that are not preferred to the user given the subject matter, timing, or other context factor.

To address these issues, various embodiments described in more detail below provide for message delivery via receiver-preferred communications applications. Examples described herein may operate by accessing data indicative of a current message, wherein the current message was sent via a first communications application for a planned delivery to a user via the first application. Data indicative of past behaviors of the user with respect to utilization of communication applications is accessed. A preferred communications application for delivering the current message to the user is identified in consideration of the past behaviors data. The current message is caused to be delivered to the user via the preferred application. In examples, the preferred application to be utilized to deliver the message is, but is not limited to, a Short Message Service (“SMS”) or other text messaging application, a phone application, or a social networking web application. In an example, the planned delivery of the message via the first application is caused to be cancelled.

In an example, identifying a preferred communications application may include identifying a relevant circumstance with respect to utilization of a communication application. The relevant circumstance is identified from the past behaviors data. Identifying the preferred communications application additionally includes consideration of a count of occurrences that the user utilized the preferred application relative to other communication applications during the relevant circumstance. In examples, the relevant circumstance to be considered includes at least one of a specific time, a time period, a specific date, and a range of dates. In examples the relevant circumstance is that the user is scheduled to attend a meeting according to a calendar application. In other examples, the relevant circumstance is the presence of the user at a location. In other examples, the relevant circumstance is that the user engaged in driving travel, passenger travel, air travel, or travel outside the user's home country.

In a particular example, presence data is accessed from a mobile computing device associated with the user, and the relevant circumstance is identified utilizing the presence data. In an example, the presence data may include positioning data or motion analytics data. In an example, the presence data is indicative that the user, or a computing device associated with user, has accessed a telephone connection, web application, or network.

In an example, the current message is a message sent at the initiation of a contact user to a recipient user through such contact user's interaction with the first application at a first computing device. In this example a response message is generated through the recipient user's interaction with the preferred application. The response message is then caused to be sent to the contact user via the first application that is favored by the contact user.

In this manner, embodiments of this disclosure present an automated and efficient manner to enable a user that receives a message via a first application to respond utilizing a second application that is preferred by the smartphone user. Users of smartphones and other computing devices with multiple installed communications applications will appreciate the ability to aggregate all incoming communication requests to a single communications application, and to transfer the messages formats into his or desired communications application format. The recipient user can select preferences rules to divert the messages based on this needs which can change, e.g., depending on location and time of the day. Rules can be implemented that will work automatically to change the preferred communications application automatically based on the recipient user's location, calendar and other presence information or preference information which can be collected on the user as time goes by. Embodiments can optimize the recipient user's utilization of his or her multiple communications applications according to personal preferences. Such advantages of the disclosure will cause customer satisfaction with the mobile computing devices, and with the optimized communications applications installed thereon, to increase.

The following description is broken into sections. The first, labeled “Environment,” describes an environment in which various embodiments may be implemented. The second section, labeled “Components,” describes examples of various physical and logical components for implementing various embodiments. The third section, labeled “Illustrative Example,” presents an example of message delivery via preferred communications applications. The fourth section, labeled as “Operation,” describes steps taken to implement various embodiments.

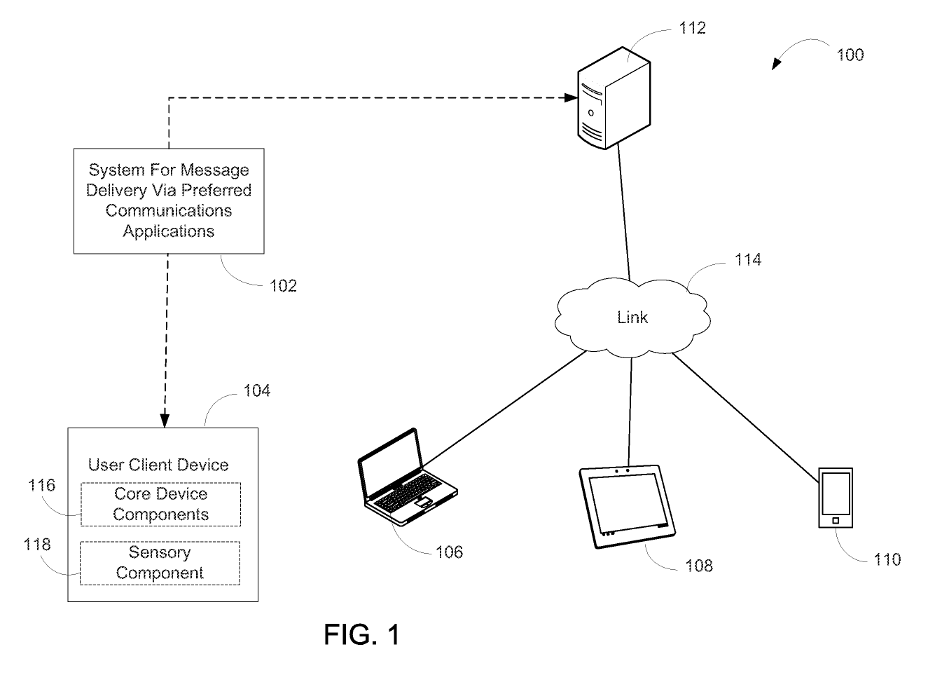

ENVIRONMENT: FIG. 1 depicts an example environment 100 in which embodiments may be implemented as system for message delivery via preferred communications applications 102. Environment 100 is show to include client devices 104, 106, 108, and 110, and a server device 112. Components 104-112 are interconnected via link 114.

Link 114 represents generally any infrastructure or combination of infrastructures configured to enable an electronic connection, wireless connection, or other connection to enable data communication between components 104-112. Such infrastructure or infrastructures may include, but are not limited to, one or more of a cable, wireless, fiber optic, or remote connections via telecommunication link, an infrared link, or a radio frequency link. For example, link 114 may represent the internet, one or more intranets, and any intermediate routers, switches, and other interfaces. As used herein an “electronic connection” refers generally to a transfer of data between components, e.g., between two computing devices, that are connected by an electrical conductor. A “wireless connection” refers generally to a transfer of data between two components, e.g., between two computing devices, that are not directly connected by an electrical conductor. A wireless connection may be via a wireless communication protocol or wireless standard for exchanging data.

Client devices 104-110 represent generally any computing device with which a user may interact to communicate with other client devices and server device 112 via link 114. Server device 112 represents generally any computing device configured to serve an application and corresponding data for consumption by client devices 104-110.

Client device 104 is shown to include core device components 116 and sensory component 118. Core device components 116 represent generally the hardware and programming for providing the computing functions for which device 104 is designed. Such hardware can include a processor and memory, display and any physical user input buttons. The programming can include an operating system and applications. Sensory component 118 represents generally any component configured to detect a change in presence of client device 104 or a user of client device 104. For example, sensory component 118 may include any of a geographic information system (“GIS”), a Global Positioning System (“GPS”), or other positioning feature, an accelerometer, a motion analytics feature, and a communication feature that can be used to detect device position and/or motion. Sensory component 118 may be software configured to detect the start and stop of phone calls, virtual meetings, and other events where the client device facilitates interaction between the user and another individual via a network other communication channel.

System 102, discussed in more detail below, represents generally a combination of hardware and programming configured to enable message delivery via preferred communications applications. Briefly, system for message delivery via preferred communications applications 102 is configured to access data indicative of a current message. The current message is a message that was sent via a first communications application for a planned delivery to a user via the first appl6ication. System 102 is to access data indicative of past behaviors of the user with respect to utilization of communication applications. System 102 is to identify, in consideration of the past behaviors data, a preferred communications application for delivering the current message to the user. System 102 is to cause the current message to be delivered to the user via the preferred application.

System 102 may be wholly integrated within core device components 116. System 102 may be implemented as a component of server device 112 where it takes action based in part on data received from core device components 116 and sensory component 118 via link 114. System 102 may be distributed across client device 104 and server device 112. For example, accessing data indicative of past behaviors of the user with respect to utilization of communication applications may be performed on client device 104, while accessing data indicative of a current message, identifying a preferred communications application, and causing the current message to be delivered to the user via the preferred application may be performed by server device 112. Other distributions of system 102 across client device 104 and server device 112 are possible and contemplated by this disclosure. It is noted that all or portions of the system for message delivery via preferred communications applications 102 may also be included on client devices 106, 108 or 110.

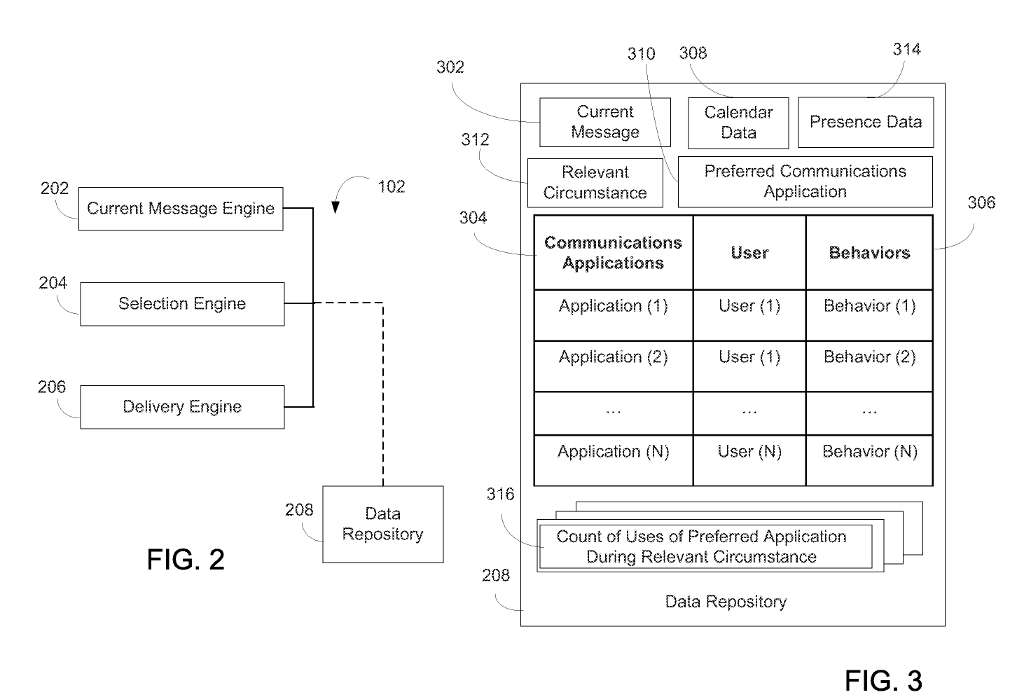

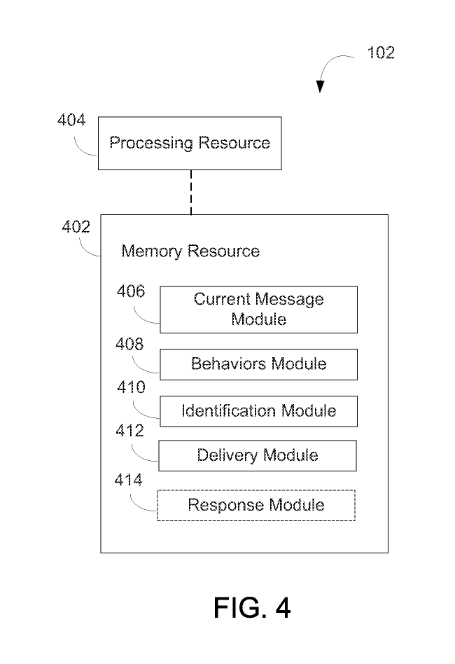

COMPONENTS: FIGS. 2-4 depict examples of physical and logical components for implementing various embodiments. In FIG. 2 various components are identified as engines 202, 204, 206. In describing engines 202, 204, 206 focus is on each engines designated function. However, the term engine, as used herein, refers generally to a combination of hardware and programming configured to perform a designated function. As is illustrated later with respect to FIG. 4, the hardware of each engine, for example, may include one or both of a processor and a memory, while the programing may be code stored on that memory and executable by the processor to perform the designated function.

FIG. 2 is a block diagram depicting components of system for message delivery via preferred communications applications 102. In this example, system 102 includes current message engine 202, selection engine 204, and delivery engine 206. In performing their respective functions, engines 202, 204, 206 may access data repository 208. Repository 208 represents generally any memory accessible to system 102 that can be used to store and retrieve data.

Current message engine 202 represents a combination of hardware and programming configured to access data indicative of a current message, wherein the current message is sent via a first communications application and addressed for delivery to a user (sometimes referred to herein as an s “addressee user” or “recipient user”) via the first application. In an example, the message is sent via the first communications application as a result of another user's (sometimes referred to herein as a “contact user”) interaction with the first communications application. In another example, the message may be a message that was sent automatically by a computing device via the first communications application. As used herein, a “communications application” refers generally to a web application, software application, firmware application, or other programming that executes at, or is accessible at, a computing device and that enables communication between users of computing devices. Examples of communications applications include, but are not limited to, social networking web applications such as Facebook® or LinkedIn®, web email applications such as Yahoo!® Mail or Gmail®, digital or cellular phone applications, SMS or other text-based messaging applications, and multiple-mode communications application such as Skype™.

Selection engine 204 represents a combination of hardware and programming configured to select a preferred communications application for delivering the current message to the addressee user. The preferred application is selected according to past behaviors of the addressee user with respect to a plurality of communication applications. As used herein, a “behavior” refers generally to any way in which a user acts or conducts his or herself, e.g., in response to a stimulus or situation such as time of day, day of the week, calendar date, presence at a location, attendance at a scheduled event, etc. Such a behavior may be evidenced by the user's interaction with one or more computing devices.

In an example, the selection engine 204 is configured to identify, from the past behaviors data, a relevant circumstance with respect to the addressee user's utilization of a communication application, and

to consider of a count of occurrences that the addressee user utilized the preferred application relative to other communication applications during the relevant circumstance. In examples, the relevant circumstance is, or includes, a specific time, time period, date, or range of dates. In other examples, the relevant circumstance is, or includes, that the addressee user is, is scheduled to be, was, or was scheduled to be at a specific location or one of a group of specified locations. In a particular example, the relevant circumstance is that the addressee user is scheduled to attend a meeting according to a calendar application. As used herein, a “calendar application” refers generally to an application with functionality to schedule gatherings, meetings, occasions, anniversaries, or other happenings. In examples, the calendar applications include functionality to enable users to send and receive invitations, invitation acceptances, invitation rejections, and invitation counterproposals regarding attendance at such happenings.

For instance, the selection engine 204 may identify a relevant circumstance of “user is in the office” (e.g., by determining via presence data the addressee user is connected to a LAN or based on time of day), and then consider a count of occurrences that the addressee user utilized different communications applications in such circumstance. The selection engine may determine by counting use occurrences that the addressee user, when in the office shows a distinct preference for utilizing an instant messaging communications application.

In another example, the selection engine 204 may identify a relevant circumstance of “user is in a meeting” (e.g., based on accessed GIS or GPS presence data indicative of the addressee user's location, or according to the addressee user's calendar or schedule), and then consider a count of occurrences that the addressee user utilized different communications applications in such relevant circumstance. The selection engine 204 may then determine by counting use occurrences that the addressee user, when in a meeting, shows a preference for utilizing a SMS text messaging communications application.

In another example, the selection engine 204 may identify a relevant circumstance of “user is out of the office” (e.g., based on presence data indicating that the addressee user's mobile device is connected to WLAN, 3G or 4G network), and then consider a count of occurrences that the addressee user utilized different communications applications in such relevant circumstance. The selection engine 204 may then determine by counting use occurrences that the addressee user, when out of the office, is more likely to utilize a social networking web communications application over other communications applications.

In another example, the selection engine 204 may identify a relevant circumstance of “away from home country” (e.g., based on GIS or GPS presence data, or data indicating that the addressee user's mobile device in international roaming mode as it is connected to a 3G or 4G network), and then consider a count of occurrences that the addressee user utilized different communications applications in such relevant circumstance. The selection engine 204 may then determine by counting use occurrences that the addressee user, when away from home country, accesses his or her multiple mode web communications application more frequently than other communications applications available to the addressee user.

In another example, the selection engine 204 may identify a relevant circumstance of “driving” (e.g., based on accessed GIS or GPS or other positioning data indicative of the addressee user's travel, according to the addressee user's calendar or schedule), and then consider a count of occurrences that the addressee user utilized different communications applications in such relevant circumstance. The selection engine 204 may then determine by counting use occurrences that the addressee user, when driving, shows a preference for utilizing a cellular phone or other phone application that emphasizes voice and will not require significant visual interaction or keystrokes to respond.

In another example, the selection engine 204 may identify a relevant circumstance of “passenger travel” (e.g., based on accessed presence data that includes GIS or GPS or other positioning data along with motion analytics data, or according to the addressee user's calendar or schedule), and then consider a count of occurrences that the addressee user utilized different communications applications in such relevant circumstance. The selection engine 204 may then determine by counting use occurrences that the addressee user, when traveling as a passenger, shows a preference for utilizing a SMS or cellular phone application.

In another example, the selection engine 204 may identify a relevant circumstance of “air travel”, and then consider a count of occurrences that the addressee user utilized different communications applications in such relevant circumstance. The selection engine 204 may then determine by counting use occurrences that the addressee user, when engaged in air travel, most often utilized a web email communications application.

The delivery engine 206 is configured to cause the current message to be delivered to the user via the identified preferred communications application. In examples, the delivery of the current message via the preferred application is instead of, or rather than, delivery via the first application. In an example, the delivery module 206 intercepts the current message such that delivery via the first communications application is cancelled.

In an example the current message is a message that was sent at the initiation of a contact user to an addressee user, through the contact user's interaction with the first application. In a particular example, the delivery engine 206 may be configured to access a response message and cause the response message to be sent to the contact user via the first communications application. The response message is a message generated in response to the addressee user interacting with the preferred application. In an example, the response message is a message composed by the addressee user, e.g., via entering of text or speech into a user interface at a computing device. In another example, the response message is a message that is pre-composed and is automatically generated for sending to the contact user in response to the addressee user interacting with a user interface at a computing device

FIG. 3 depicts an example implementation of data repository 208. In this example, repository 208 includes current message data 302, communications applications data 304, behaviors data 306, and calendar data 308. Calendar data 308 is indicative of calendar data such as gatherings, meetings, occasions, anniversaries, or other happenings, or invitations, invitation acceptances, invitation rejections, and invitation counterproposals regarding user attendance at such happenings.

Referring back to FIG. 2 in view of FIG. 3, in an example, current message engine 202 may access current message data 302 data indicative of a current message 310. The current message was sent via a first communications application for a Warmed delivery to a recipient user via the first application. The selection engine 204 may access behaviors data 306 that is indicative of past behaviors of the recipient user with respect to utilization of communication applications. The selection engine 204 may identify, in consideration of the behaviors data 306, a preferred communications application 310 for delivering the current message to the recipient user.

In an example, the selection engine 204 may, in identifying the preferred communications application 310, identify, from the behaviors data 306, a relevant circumstance 312 with respect to the recipient user's utilization of a communication application. The selection engine 204 may then take into account consideration of a count of occurrences 316 that the recipient user utilized the preferred application 310 relative to other communication applications during the relevant circumstance 312. In examples a relevant circumstance may be a specific time or period that the recipient user is, is scheduled to be, was, or was scheduled to be at a specific location or one of a group of specified locations. In other examples, a relevant circumstance may be that the recipient user is or was engaged in a particular activity, or is or was otherwise in a particular state or status.

In examples, the selection engine 204 may access presence data 314 and utilize presence data 314 in identifying the relevant circumstance 312. Referring back to FIG. 2, in examples the selection engine 204 may access presence data 314 that is generated, aggregated, collected or received via sensory component 118. As used herein, “presence data” refers generally to data that indicates a location or, state, or status of a user or a computing device associated with a user. In an example, the presence data that is accessed and utilized to identify a failure to attend is or includes GIS data, GPS data, triangulation data, or other positioning data. In an example, the presence data that is accessed and utilized to identify a failure to attend is motion analytics data, e.g., motion analytics data collected at a mobile computing device that analyzes user walk gait or other motions analytics to determine a particular user is utilizing the mobile device. In another example, the location or status of a user is identified by success or failure of the user or a computing device associated with user to access a telephone connection, web application, network, or other communications vehicle designated in a meeting invitation. In another example, the presence data 314 utilized in identifying a recipient user's location or status includes calendar data 308.

Following identification of a preferred communications application 310, the delivery engine 206 may cause the current message to be delivered to the recipient user via the preferred communications application, rather via than the first communication application as addressed in the current message.

In the foregoing discussion, engines 202, 204, 206 were described as combinations of hardware and programming. Engines 202, 204, 206 may be implemented in a number of fashions. Looking at FIG. 4, the programming may be processor executable instructions stored on a tangible memory resource 402 and the hardware may include a processing resource 404 for executing those instructions. Thus memory resource 402 can be said to store program instructions that when executed by processing resource 404 implement system 102 of FIGS. 1 and 2.

Memory resource 402 represents generally any number of memory components capable of storing instructions that can be executed by processing resource 404. Memory resource 402 is non-transitory in the sense that it does not encompass a transitory signal but instead is made up of more or more memory components configured to store the relevant instructions. Memory resource 402 may be implemented in a single device or distributed across devices. Likewise, processing resource 404 represents any number of processors capable of executing instructions stored by memory resource 402. Processing resource 404 may be integrated in a single device or distributed across devices. Further, memory resource 402 may be fully or partially integrated in the same device as processing resource 404, or it may be separate but accessible to that device and processing resource 404.

In one example, the program instructions can be part of an installation package that when installed can be executed by processing resource 404 to implement system 102. In this case, memory resource 402 may be a portable medium such as a CD, DVD, or flash drive or a memory maintained by a server from which the installation package can be downloaded and installed. In another example, the program instructions may be part of an application or applications already installed. Here, memory resource 402 can include integrated memory such as a hard drive, solid state drive, or the like.

In FIG. 4, the executable program instructions stored in memory resource 402 are depicted as a current message module 406, a behavior module 408, an identification module 410, and a delivery module 412. Certain embodiments may also include a response module 414. Current message module 406 represents program instructions that when executed may cause processing resource 404 to cause the implementation of current message engine 202 of FIG. 2. Behavior module 408 represents program instructions that when executed cause processing resource 404 to cause the implementation of a portion of selection engine 204 of FIG. 2. Specifically, the behavior module 408 causes accessing data indicative of past behavior of a first user with respect to utilization of communication applications. Identification module 410 represents program instructions that when executed cause processing resource 404 to cause the implementation of a portion of selection engine 204 of FIG. 2. Specifically, the identification module 410 causes identifying, in consideration of the past behavior data, a preferred communications application for delivering the current message to the first user. Delivery module 412 represents program instructions that when executed cause processing resource 404 to cause the implementation of a portion of delivery engine 206 of FIG. 2. Specifically, the delivery module 408 causes the current message to be delivered to the first user via the preferred application. Response module 414 represents program instructions that when executed cause processing resource 404 to cause the implementation of a portion of delivery engine 206 of FIG. 2. Specifically, the response module 408 causes accessing of a response message that was generated as a result of the first user's interaction with the preferred application. The response module further causes sending of the response message to a second user via the first application.

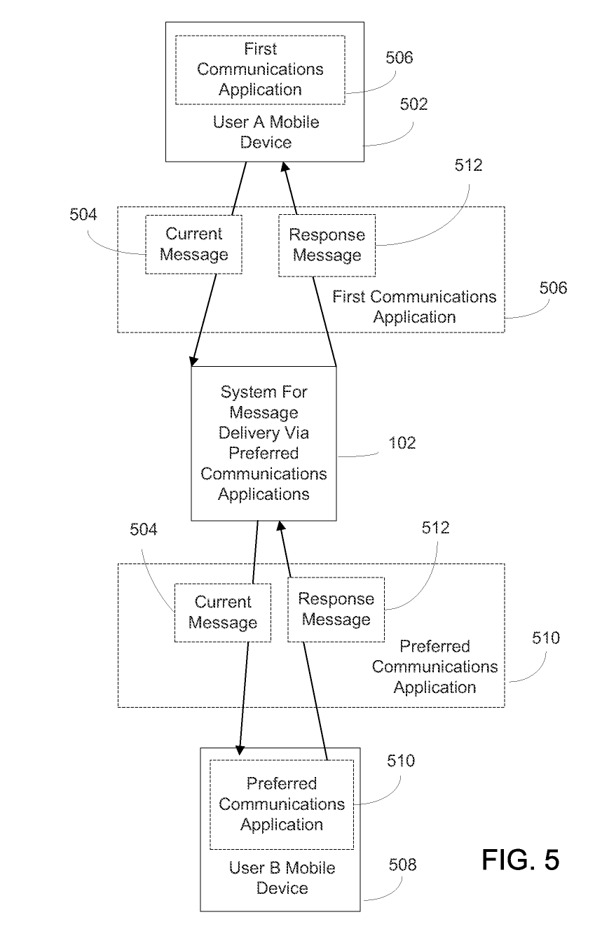

ILLUSTRATIVE EXAMPLE: FIG. 5 is a block diagram depicting an example of message delivery via preferred communications applications. In this example, a first user “A” interacting with a User A mobile computing device 502, causes a current message 504 to be sent from the User A Mobile Device via a first communications application 506 for planned delivery to a user “B” via the first communications application 506. In examples, the first communications application may be a social networking web application, a web email application, a telephone or other voice communications application, a video communications application, a SMS or other text messaging communications application, a multiple modality communications application, or any other example of a communications application. The current message 504 directed to User B via the first communications application 506 may be caused to be intercepted or otherwise accessed by system 102.

System 102 is a system for message delivery via preferred communications applications. System 102, may be implemented as a component of User B mobile computing device 508, as a component of a server computing device or client computing device separate from device 508, or may be distributed across multiple computing devices.

System 102, upon accessing current message 504, accesses data indicative of past behaviors of User B as User B utilized a set of communication applications. The system 102 identifies a preferred communications application 510 for delivering the current message 504 according to formula or rule that considers such past behaviors data. In an example, system 102 in identifying the preferred application 510 identifies, from the past behaviors data, a relevant circumstance with respect to utilization of a communication application and applies a formula or rule that considers a count of occurrences that the user utilized the preferred application 510 relative to other communication applications during the relevant circumstance. In an example, the preferred communications application 510 is identified as such as a result of being the communications application with the highest number of occurrences of use during the relevant circumstance. In examples, the preferred communications application 510 may be a social networking web application, a web email application, a telephone or other voice communications application, a video communications application, a SMS or other text messaging communications application, a multiple modality communications application, or any other example of a communications application.

System 102 causes the current message 504 to be delivered to User B at the User B Mobile Device 508 via the preferred application 510. In an example, system 102 may be additionally configured to access a response message 512 and cause the response message 512 to be sent to User A at the User A Mobile Device 502 via the first communications application 506.

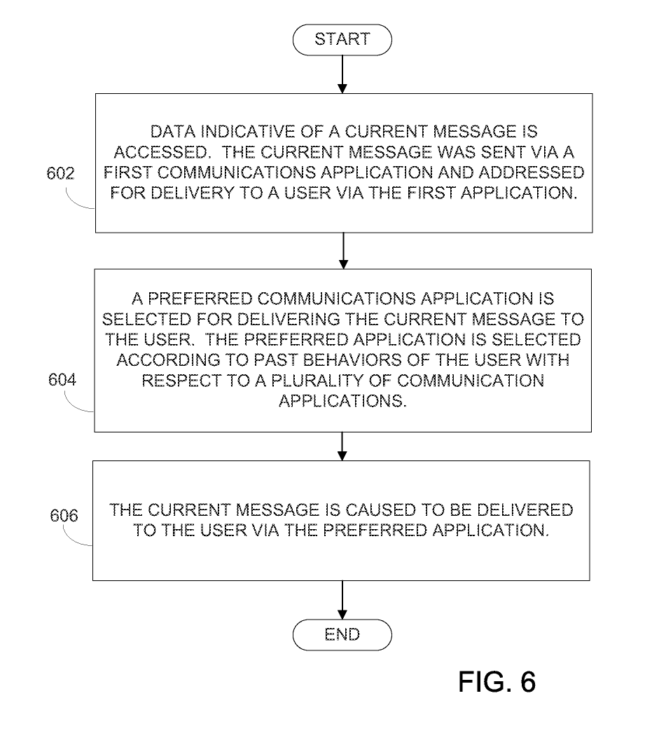

OPERATION: FIG. 6 is a flow diagram of steps taken to implement a method for applying management actions to calendar conflicts. In discussing FIG. 6, reference may be made to the components depicted in FIGS. 2 and 4. Such reference is made to provide contextual examples and not to limit the manner in which the method depicted by FIG. 6 may be implemented.

Data indicative of a current message is accessed. The current message was sent via a first communications application and addressed for delivery to a user via the first application. (block 602). Referring back to FIGS. 2 and 4, current message engine 202 (FIG. 2) or current message module 406, when executed by processing resource 404, may be responsible for implementing block 602.

A preferred communications application is selected for delivering the current message to the user. The preferred application is selected according to past behaviors of the user with respect to a plurality of communication applications (block 604). Referring back to FIGS. 2 and 4, selection engine 204 (FIG. 2), or behaviors module and identification modules 408, 410, when executed by processing resource 404, may be responsible for implementing block 604.

The current message is caused to be delivered to the user via the preferred application (block 606). Referring back to FIGS. 2 and 4, delivery engine 206 (FIG. 2), or delivery module 412, when executed by processing resource 404, may be responsible for implementing block 606.

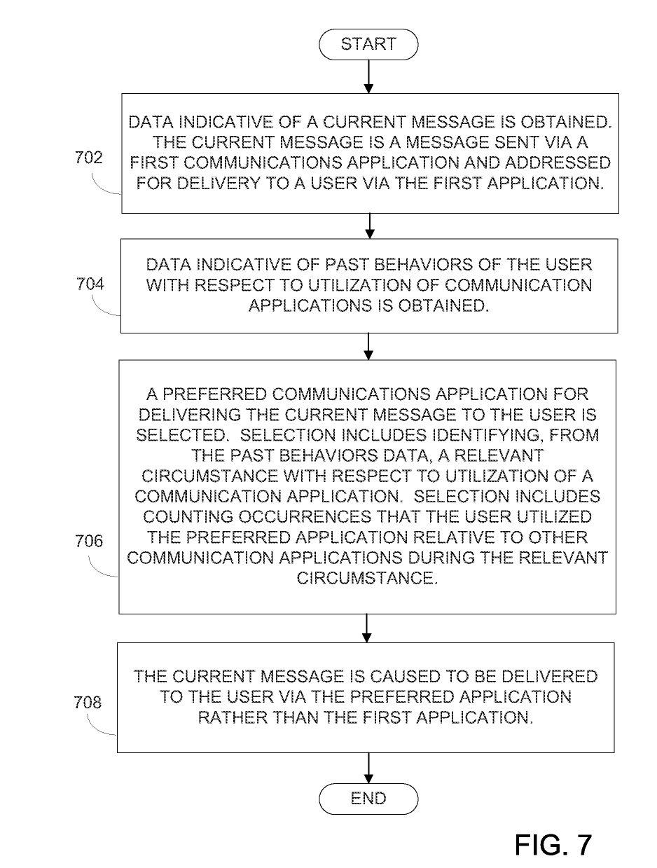

FIG. 7 is a flow diagram of steps taken to implement a method for applying management actions to calendar conflicts. In discussing FIG. 7, reference may be made to the components depicted in FIGS. 2 and 4. Such reference is made to provide contextual examples and not to limit the manner in which the method depicted by FIG. 7 may be implemented.

Data indicative of a current message is obtained. The current message is a message sent via a first communications application and addressed for delivery to a user via the first application (block 702). Referring back to FIGS. 2 and 4, current message engine 202 (FIG. 2) or current message module 406, when executed by processing resource 404, may be responsible for implementing block 702.

Data indicative of past behaviors of the user with respect to utilization of communication applications is obtained (block 704). Referring back to FIGS. 2 and 4, selection engine 204 (FIG. 2) or behaviors module 408, when executed by processing resource 404, may be responsible for implementing block 704.

A preferred communications application for delivering the current message to the user is selected. Selection includes identifying, from the past behaviors data, a relevant circumstance with respect to utilization of a communication application. Selection includes counting occurrences that the user utilized the preferred application relative to other communication applications during the relevant circumstance (block 706). Referring back to FIGS. 2 and 4, selection engine 204 (FIG. 2) or identification module 410, when executed by processing resource 404, may be responsible for implementing block 706.

The current message is caused to be delivered to the user via the preferred application rather than the first application (block 708). Referring back to FIGS. 2 and 4, delivery engine 206 (FIG. 2) or delivery module 412, when executed by processing resource 404, may be responsible for implementing block 708.

CONCLUSION: FIGS. 1-7 aid in depicting the architecture, functionality, and operation of various embodiments. In particular, FIGS. 1-4 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagrams of FIGS. 6 and 7 show specific orders of execution, the orders of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A memory resource storing instructions that when executed cause a processing resource to implement a system for message delivery, the instructions comprising:
a current message module for accessing data indicative of a current message, the current message sent via a first communications application for a planned delivery to a user via the first application;
a behaviors module for accessing data indicative of past behaviors of the user with respect to utilization of communication applications;
an identification module for identifying, in consideration of the past behaviors data, a preferred communications application for delivering the current message to the user; and
a delivery module for causing the current message to be delivered to the user via the preferred application.

2. The medium of claim 1, wherein the delivery module includes instructions for causing the planned delivery via the first application to be cancelled.

3. The medium of claim 1, wherein identifying a preferred communications application includes
identifying, from the past behaviors data, a relevant circumstance with respect to utilization of a communication application; and
consideration of a count of occurrences that the user utilized the preferred application relative to other communication applications during the relevant circumstance.

4. The medium of claim 1, wherein the preferred application includes at least one of a text messaging application, a phone application, and a social networking web application.

5. The medium of claim 3, wherein the relevant circumstance includes at least one of a specific time, a time period, a specific date, and a range of dates.

6. The medium of claim 3, wherein the relevant circumstance is the presence of the user at a location.

7. The medium of claim 3, wherein the identification module includes instructions for accessing presence data from a mobile computing device associated with the user and the relevant circumstance is identified utilizing the presence data.

8. The medium of claim 7, wherein the presence data includes positioning data or motion analytics data.

9. The medium of claim 7, wherein the presence data is indicative that the user, or a computing device associated with user, has accessed a telephone connection, web application, or network.

10. The medium of claim 1,
wherein the user is a first user;
wherein the current message was sent at the initiation of a second user through interaction with the first application;
further comprising a response module for
accessing a response message generated responsive to interaction of the first user with the preferred application, and
causing sending of the response message to the second user via the first application.

11. A message delivery system, comprising
a current message engine to access data indicative of a current message, the current message sent via a first communications application and addressed for delivery to a user via the first application;
a selection engine to select a preferred communications application for delivering the current message to the user, wherein the preferred application is selected according to past behaviors of the user with respect to a plurality of communication applications; and
a delivery engine to cause the current message to be delivered to the user via the preferred application instead of via the first application.

12. The system of claim 11, wherein selecting a preferred communications application includes 1 identifying, from the past behaviors data, a relevant circumstance with respect to utilization of a communication application; and
applying a rule that considers a count of occurrences that the user utilized the preferred application relative to other communication applications during the relevant circumstance.

13. The system of claim 12, wherein the relevant circumstance is that the user is scheduled to attend a meeting according to a calendar application.

14. The system of claim 12, wherein the relevant circumstance includes at least one of a driving travel, a passenger travel, an air travel, or a travel outside the user's home country.

15. A method for message delivery, comprising:
obtaining data indicative of a current message, the current message sent via a first communications application and addressed for delivery to a user via the first application;
obtaining data indicative of past behaviors of the user with respect to utilization of communication applications;
selecting a preferred communications application for delivering the current message to the user; including
identifying, from the past behaviors data, a relevant circumstance with respect to utilization of a communication application, and
counting occurrences that the user utilized the preferred application relative to other communication applications during the relevant circumstance; and
causing the current message to be delivered to the user via the preferred application, wherein the current message is not delivered to the user via the first application.
